(19) United States
(12) Patent Application Publication
(10) Pub. No.: US 2013/0337233 A1
(43) Pub. Date: Dec. 19, 2013

(54) Glass-Strengthening Coating Material, Strengthened Glass Block and Touch-Sensitive Display Device Protected by Strengthened Glass

(71) Applicant: Wintek Corporation, Taichung City (TW)

(72) Inventors: Chien-Chung CHEN, Tai Chung City (TW); Jeng-Jye HUNG, Tai Ping City (TW); Hen-Ta KANG, Tai Chung City (TW)

(21) Appl. No.: 13/918,595

(22) Filed: Jun. 14, 2013

(30) Foreign Application Priority Data
Jun. 18, 2012 (TW) 101121669
Nov. 7, 2012 (TW) 101141241

(51) Int. Cl. C03C 17/00; G06F 1/16

(52) U.S. Cl. CPC C03C 17/00; G06F 1/1601
USPC 428/161; 428/426; 428/429; 428/428; 106/287.12; 106/286.7; 106/286.2; 522/182; 522/170

(57) ABSTRACT

A glass-strengthening coating material is applied to a surface area without a strengthened layer or a newly-born surface area of a strengthened glass block subject to a preliminary chemically strengthened treatment. The newly-born surface area is formed as a result of machining or material removing treatments, and the glass-strengthening coating material is selected from the group consisting of inorganic polymer, organic polymer, and organic/inorganic hybrid polymer.

### BACKGROUND OF THE INVENTION

a. Field of the Invention

The invention relates to a glass-strengthening coating material and to a strengthened glass block applied with the glass-strengthening coating material.

b. Description of the Related Art

Generally, conventional methods for strengthening glass mainly include a physically strengthening treatment and a chemically strengthening treatment. For example, in a typical chemically strengthening treatment, an ion-exchange phenomenon occurs in the glass skin to form a chemically strengthened layer. Under the circumstance, a compression stress layer is correspondingly formed in the glass skin as a result of the chemically strengthened layer and capable of constraining the growth of cracks in the glass skin to enhance the glass strength. In a typical process of performing a chemically strengthening treatment, a glass substrate to be strengthened is entirely dipped into high-temperature potassium molten salts for ion-exchange. However, such process is difficult to strengthen only a part of the glass substrate, and the necessary high-temperature may damage a coating on the glass substrate. Further, if the chemically strengthened glass substrate undergoes subsequent machining processes, the machining processes may remove a part of the strengthened layer already formed on the glass substrate or create a newly-born surface without the strengthened layer. Therefore, for a strengthened glass substrate having been subject to machining processes, it is relatively easy to grow cracks on a surface area without the strengthened layer to therefore reduce the glass strength.

### BRIEF SUMMARY OF THE INVENTION

The invention provides a glass-strengthening coating material and a strengthened glass block having enhanced strength, where a strengthened layer is formed on an entire surface of the strengthened glass block by the use of the glass-strengthening coating material.

The invention further provides a touch-sensitive display device protected by strengthened glass.

Other objects and advantages of the invention can be better understood from the technical characteristics disclosed by the invention.

According to an embodiment of the invention, a glass-strengthening coating material is provided. The glass-strengthening coating material is applied to a surface area without a strengthened layer or a newly-born surface area of a strengthened glass block subject to a preliminary chemically strengthened treatment. The newly-born surface area is formed as a result of machining or material removing treatments, and the glass-strengthening coating material is selected from the group consisting of inorganic polymer, organic polymer, and organic/inorganic hybrid polymer.

According to another embodiment of the invention, a strengthened glass block is cut from a mother glass substrate given a preliminary chemically strengthening treatment. The strengthened glass block has a preliminary strengthened surface area and at least one newly-born surface area. The newly-born surface area is formed as a result of a machining or material removing treatment, and a glass-strengthening coating material is at least formed on the newly-born surface area. The glass-strengthening coating material is selected from the group consisting of inorganic polymer, organic polymer, and organic/inorganic hybrid polymer.

According to another embodiment of the invention, a touch-sensitive display device protected by strengthened glass includes a cover lens, a glass-strengthening coating material, and a touch-sensitive display panel. The glass-strengthening coating material is formed on at least a part of the cover lens, and the glass-strengthening coating material is selected from the group consisting of inorganic polymer, organic polymer, and organic/inorganic hybrid polymer. The touch-sensitive display panel is disposed on the cover lens,

According to the above embodiments, a glass-strengthening coating material is used to form a chemically strengthened layer on a newly-born surface area or to reinforce the original strengthened layer that is weaken or removed in part as a result of machining or material removing treatments. Therefore, a chemically strengthened layer and a corresponding compression stress layer are formed on the entire surface to further enhance the overall strength, Since the glass-strengthening coating material may be disposed on a glass substrate by coating, it becomes easier to give the glass substrate local reinforcement. Besides, the glass-strengthening coating material may fill cracks in the glass skin to further enhance glass strength. In addition, since the glass-strengthening coating material has a low curing temperature, the low curing temperature does a coating layer on the glass substrate no harm to thus increase production yields and reliability.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating the effect of a glass-strengthening coating material according to an embodiment of the invention.

FIG. 2 shows a schematic diagram illustrating a machining or material removing treatment and a secondary chemically strengthening treatment on a glass substrate according to an embodiment of the invention.

FIG, 3 shows a schematic diagram illustrating a machining or material removing treatment and a secondary chemically strengthening treatment on a glass substrate according to another embodiment of the invention.

FIG. 4 shows a schematic diagram illustrating a machining or material. removing treatment and a secondary chemically strengthening treatment on a glass substrate according to another embodiment of the invention,

FIG. 5 shows a schematic diagram illustrating a machining or material removing treatment and a secondary chemically strengthening treatment on a glass substrate according to another embodiment of the invention.

FIG. 6 shows, a schematic cross-section illustrating a cover lens provided with a decorative layer and in combination with a touch-sensing structure to form a display device according to an embodiment of the invention.

FIG. 7 shows a plan view illustrating the cover lens and touch-sensing structure of FIG. 6 according to an embodiment of the invention.

FIG. 8 shows a plan view illustrating the cover lens and touch-sensing structure of FIG. 6 according to another embodiment of the invention.

FIG. 9 shows a schematic cross-section of a cover lens having a curved side surface and combining with a touch panel and a display device according to an embodiment of the invention.

FIG. 10 shows a schematic cross-section of a display device having a touch-sensing structure on a top substrate or a sealing cap according to an embodiment of the invention.

FIG. 11 shows a schematic cross-section of a touch-sensing structure disposed on a cover lens and a substrate according to an embodiment of the invention.

FIG. 12 shows a schematic cross-section of an organic light emitting diode display device having a touch-sensing structure disposed on a sealing cap according to an embodiment of the invention.

FIG. 13 shows a schematic cross-section of a cover lens serving as a sealing cap of an organic light emitting diode display device and having a touch-sensing structure thereon according to an embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. it is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The invention provides a glass-strengthening coating material applied over a part or an entire area of glass to be strengthened by coating or dipping to achieve partial or entire chemically strengthening effects. For example, a chemically strengthened layer may not be formed in some surface area of a glass substrate given a preliminary chemically strengthening treatment, or a glass substrate given a preliminary chemically strengthening treatment may be subject to at least one machining or material removing treatment to form a newly-born surface area without a chemically strengthened layer. The glass-strengthening coating material may be applied to the aforementioned surface area without a chemically strengthened layer or the newly-born surface area to provide chemically strengthening effects. Moreover, except for applying the coating material to part of a strengthened glass substrate to provide partially reinforced effects, the coating material may be applied to the entire surface area of a strengthened or non-strengthened glass substrate according to actual demands.

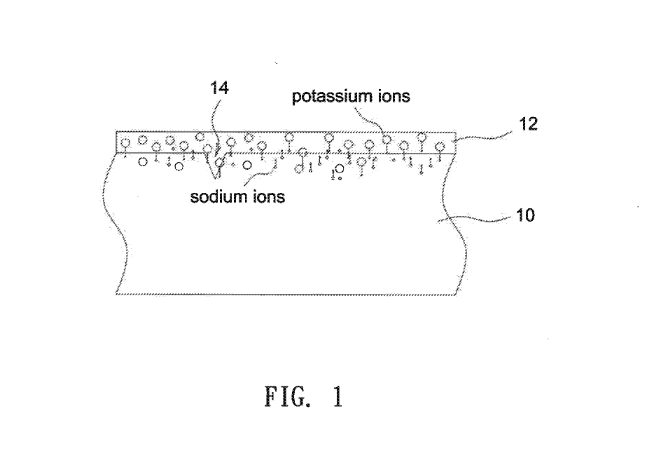

As shown in FIG. 1, according to an embodiment of the invention, a glass-strengthening coating material 12 is silicon oxide sol-gel (SiO₂ sol-gel) including potassium salt. When the glass-strengthening coating material 12 is coated on a surface of a glass substrate 10, potassium ions of the glass-strengthening coating material 12 and sodium ions on the skin of the glass substrate 10 perform ion-exchange after being heated to form a chemically strengthened layer. Under the circumstance, a compression stress layer is formed on the skin of the glass substrate 10, and a tensile stress is correspondingly formed inside the glass substrate 10 to compensate the compression stress of the compression stress layer. A thicker compression stress layer may enhance the capability of constraining the growth of cracks to much more strengthen the glass substrate 10 and increase the resistance to an impact of a foreign body. In addition, a silica layer contained in the glass-strengthening coating material 12 may also provide the effect of filling cracks 14 in the glass skin.

(Formulation Example 1)

The glass-strengthening coating material 12 is inorganic polymer, preferably comprising silicon oxide sol-gel (SiO₂ sol-gel) and potassium salt, and the SiO₂ sol-gel is derived from organic silane and formed by a sol-gel method. Details are as follows:

(1) SiO₂ sol-gel, where SiO₂ sol-gel is derived by hydrolysis and polymerization of a silane precursor and the silane precursor is, for example, tetraethoxysilane, tetramethxysilane, vinyltrimethoxysilane or methyltrimethoxysilane; and

(2) 1-30 wt % of potassium salt, where the potassium salt includes, for example, at least one of potassium dihydrogen phosphate, potassium manganate, potassium ferrate, potassium nitrate, potassium formate, potassium ferric oxalate, and aluminium potassium sulfate. The potassium salt is used to realize ion-exchange to form a chemically strengthened layer. Besides, the dissolved potassium salt may form ions used to prevent crosslinking between molecules so as to prolong the time for sol becoming gel; that is, the storage life of the coating material.

The glass-strengthening coating material 12 may be made from the aforementioned raw materials at pH 1-4, and a curing (hardening) temperature of the glass-strengthening coating material 12 may be 100-480° C.

Certainly, in an alternate embodiment, potassium salt may be excluded and only the silica layer is used to provide the effects of filling cracks in the glass skin and increasing the resistance to an impact of a foreign body. Besides, the inorganic polymer is not limited to silicon oxide sol-gel and may be selected from other organic silanes. Preferably, the inorganic polymer is derived from silicon alkoxides and made by a sol-gel method. In addition, the inorganic polymer may be aluminum silicates having a three-dimensional structure.

(Formulation Example 2)

The glass-strengthening coating material is organic/inorganic hybrid polymer, comprising:

(1) silicon oxide sol-gel (SiO₂ sol-gel), where SiO₂ sol-gel is derived by hydrolysis and polymerization of a silane precursor and the silane precursor is, for example, tetraethoxysilane, tetramethoxysilane, vinyltrimethoxysilane or methyltrimethoxysilane;

(2) acrylates, such as 2-hydroxyethyl methacrylate or dipentaerythritol hexacrylate, where acrylates may be added after the hydrolyzing process of the silicon oxide sol-gel preparation is performed to hybrid with silicon oxide sol-gel to form acrylate/silicon oxide hybrid material, thus increasing toughness of the coating material and the capability to absorb impact forces; and

(3) 1-30 wt % of potassium salt, where the potassium salt includes, for example, at least one of potassium dihydrogen phosphate, potassium manganate, potassium ferrate, potassium nitrate, potassium formate, potassium ferric oxalate, and aluminium potassium sulfate.

The glass-strengthening coating material 12 may be made from the aforementioned raw materials at pH 1-4, and a curing (hardening) temperature of the glass-strengthening coating material 12 may be 100-480° C.

Certainly, in an alternate embodiment, potassium salt may be excluded and only the acrylate/silicon oxide hybrid material is added to increase toughness of the coating material, as compared with the formulation example 1. In addition, other organic/inorganic hybrid polymers formed by various resins (for example, PU, silica gel, epoxy, adamantine, PC, PE, PS resins, etc.) modified by silicon, silane or siloxane may also be used.

(Formulation Example 3)

The glass-strengthening coating material is organic polymer, preferably a UV curable resin that is a photo-polymerizable resin, and the UV curable resin may be an acrylic resin or an epoxy resin. The acrylic UV curable resin generally includes acrylaic oligomers or monomers, photo-initiator, and other additives, where the oligomers or monomers contain acrylic moiety. When light induces the photo-initiator to generate free radicals, the acrylic moiety may react with the radicals to achieve the purpose of photo-curing or hardening. The epoxy UV curable resin generally includes resin, photo-initiator, filler, and other additives. After the photo-initiator absorbs light, a series of reactions occur to form proton acid and thus to initiate a photo-curing reaction. It should be noted that the photo-polymerizable resin as recited in the above embodiment may be also thermally polymerizable. Certainly, the organic polymer according to the the invention may be selected from various themo-polymerizable resins, such as acrylic thermosetting resins, thermo-curable PU resins, or thermo-curable epoxy resins. The thermo-polymerizable resins are not described in detail here as they are well-known in the art.

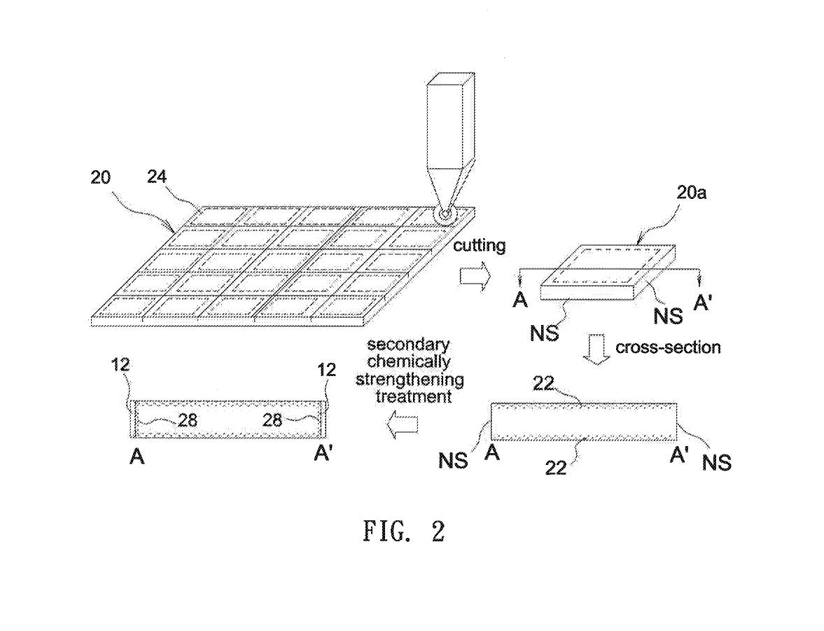

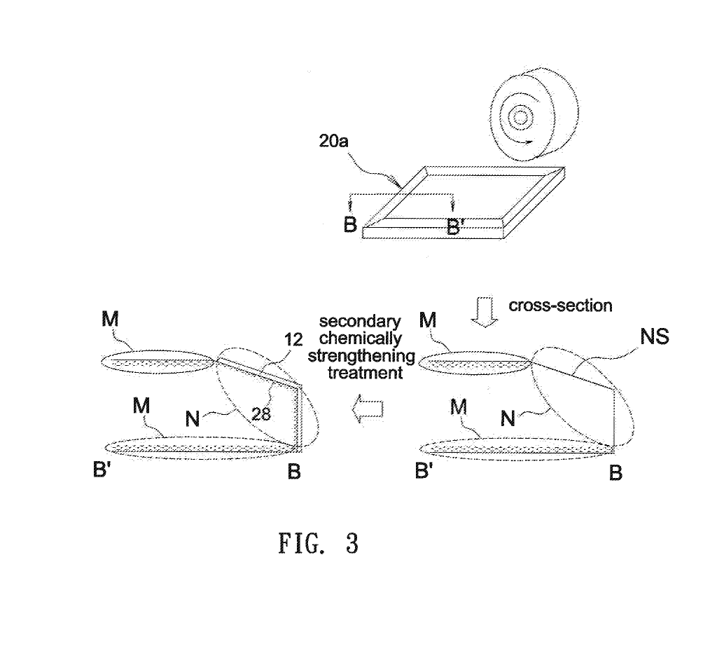

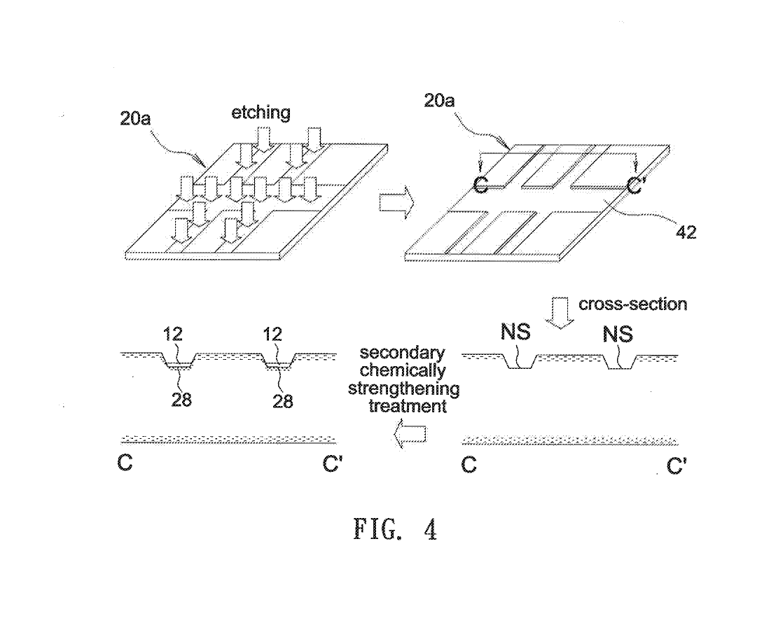

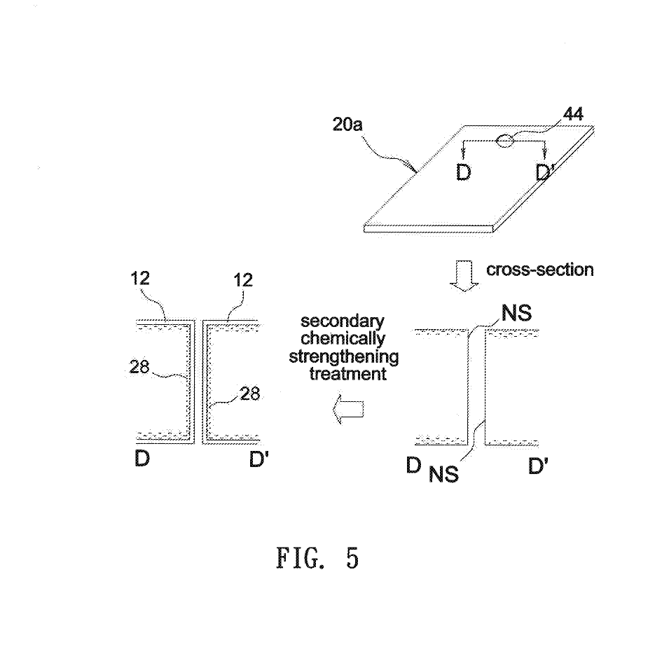

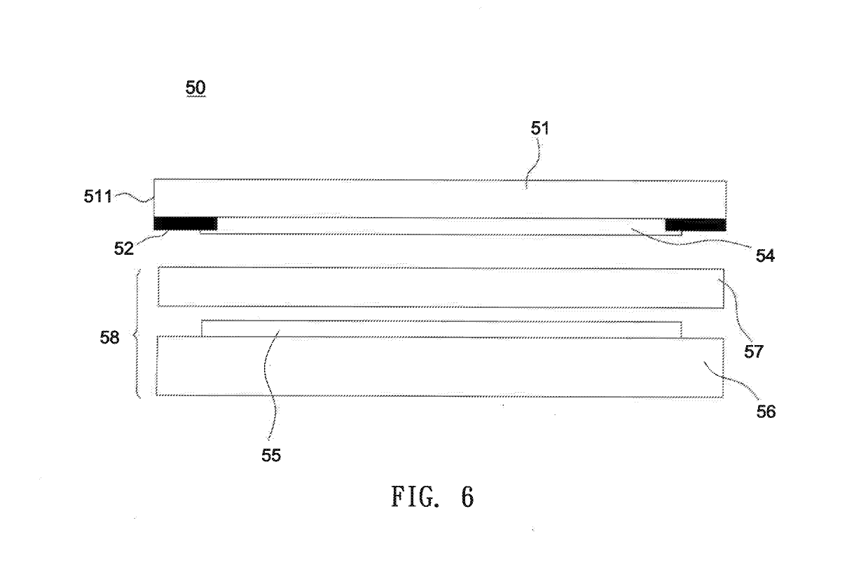

The chemically strengthening effects of a glass-strengthening coating material are exemplified in the following embodiments, where the glass-strengthening coating material is applied to a strengthened mother glass substrate that has been given a preliminary chemically strengthening treatment and then given at least one machining or material removing treatment. As shown in FIG. 2, a mother glass fabrication process is performed on a strengthened mother glass substrate 20 having been given a preliminary chemically strengthening treatment. Herein, the mother glass fabrication process means necessary processes for producing a finished product and performed on a mother glass substrate. For example, in case a strengthened glass substrate serves as a substrate or a cover lens of a touch panel, the mother glass fabrication process may include a first photolithography process for forming metal traces, a second photolithography process for forming an insulation layer, a third photolithography process for forming multiple first sensing series and second sensing series, and forming a decorative layer by a photolithography, screen printing or ink printing process. In that case, multiple touch-sensing structures 24 to be separated are formed on the strengthened mother glass substrate 20. The material of the decorative layer includes at least one of diamond-like carbon, ceramic, colored ink, resin and photo resist. Also, the decorative layer may be formed on a touch panel, a display panel, or a cover lens or a glass substrate of other electronic product. Alternatively, in case the strengthened glass substrate serves as a transparent substrate of a display panel, the mother glass fabrication process may include depositing metal and dielectric materials and performing photolithography and etching processes on a strengthened mother glass substrate 20 to form a display unit. The display unit includes, but not limited to, a light-emitting diode (LED) unit or an organic light-emitting diode (OLED) unit. After the mother glass fabrication process has been carried out, the strengthened mother glass substrate 20 is cut to directly form multiple strengthened glass blocks 20a each having a stack of films. Therefore, a product may be produced by the mother glass fabrication process with simplified procedures and reduced fabrication time and costs. Further, since the aforementioned cutting treatment allows each strengthened glass block 20a to form four newly-born surfaces NS (i.e., four cut facets), and each of the newly-born surfaces NS is not provided with a chemically strengthened layer 22, the strengthened glass block 20a is then coated with a glass-strengthening coating material 12 to form a chemically strengthened layer 28 and correspondingly form a compression stress layer on the newly-born surface NS. Therefore, a chemically strengthened layer and a compression stress layer formed as a result of the chemically strengthened layer are provided on the entire strengthened glass block 20a to enhance the overall strength of the strengthened glass block 20a. As shown in FIG. 3, the strengthened glass block 20a may be edged by grinding to form a newly-born surface NS without a chemically strengthened layer or with a slight residue of a chemically strengthened layer. After the strengthened glass block 20a is applied with the glass-strengthening coating material 12, a chemically strengthened layer 28 is similarly formed on the newly-born surface NS. Therefore, according to the above embodiments, a strengthened glass block 20a cut from a mother glass substrate 20 having been given a preliminary chemically strengthening treatment is provided, where the strengthened glass block 20a has a preliminary strengthened surface area M and at least one newly-born surface area N, and the newly-born surface area N is formed as a result of at least one machining or material removing treatment. Further, a chemically strengthened layer 28 is at least formed on the newly-born surface area N by coating the glass-strengthening coating material 12. Besides, except for the newly-born surface area N, the chemically strengthened layer 28 may be optionally formed on part of the preliminary strengthened surface area M, such as being formed in a selected region of the preliminary strengthened surface area M near the newly-born surface area N, to further increase the glass strength of the selected region. If necessary, the glass-strengthening coating material 12 may be applied to the entire surface of the strengthened glass block 20a. Certainly, the machining or material removing treatment is not limited to specific processes, as long as a newly-born surface area N is formed. For example, the strengthened glass block 20a may be, for example, etched (a notch 42 shown in FIG. 4 is etched on the strengthened glass block 20a), drilled (a hole 44 shown in FIG. 5 and penetrating or not penetrating the strengthened glass block 20a), polished or rounded to form a newly-born surface NS, and the glass-strengthening coating material 12 at least covers the newly-born surface area N. Under the circumstance, a chemically strengthened layer and a corresponding compression stress layer are formed on the entire surface of a strengthened glass block 20a to enhance the overall strength. Certainly, the strengthened glass block 20a may be given multiple different machining or material removing treatments, and then the newly-born surface with a final shape is subject to a secondary chemically strengthening treatment. For example, the strengthened glass block 20a is first given machining treatments such as cutting, edging and chamfering operations, and peripheral cracks formed as a result of the machining treatments are removed by etching using an etching agent such as hydrofluoric acid. Accordingly, the bending strength of the machined glass block 20a is increased to eliminate or reduce the formation of cracks on bending the machined glass block 20a. Then, the machined glass block 20a is coated with the glass-strengthening coating material 12 to form a chemically strengthened. layer on the entire surface of the strengthened glass block 20a.

In the above embodiments, the glass-strengthening coating material 12 is disposed in the glass skin by coating. However, this in not limited, in an alternate embodiment, the glass substrate may be partially or completely dipped into the glass-strengthening coating material 12 to form a chemically strengthened layer.

According to the above embodiments, a glass-strengthening coating material is used to form a chemically strengthened layer on a newly-born surface area or to reinforce the original strengthened layer that is weaken or removed in part as a result of machining or material removing treatments. Therefore, a chemically strengthened layer and a corresponding compression stress layer are formed on the entire surface to farther enhance the overall strength of a strengthened glass block. Since the glass-strengthening coating material containing potassium salt may be disposed on a glass substrate by coating to achieve ion-exchange strengthening effects, it becomes easier to give the glass substrate local reinforcement. Besides, inorganic or organic polymer (such as SiO₂ layer or UV curable resin) in the glass-strengthening coating material may fill cracks in the glass skin to further enhance glass strength. In addition, compared with a conventional chemically strengthening treatment where a glass substrate is dipped into high-temperature potassium molten salt, since a curing temperature for the glass-strengthening coating material containing potassium salt may be lowered to about 100° C., the low curing temperature does a coating layer on the glass substrate no harm to increase production yields and reliability.

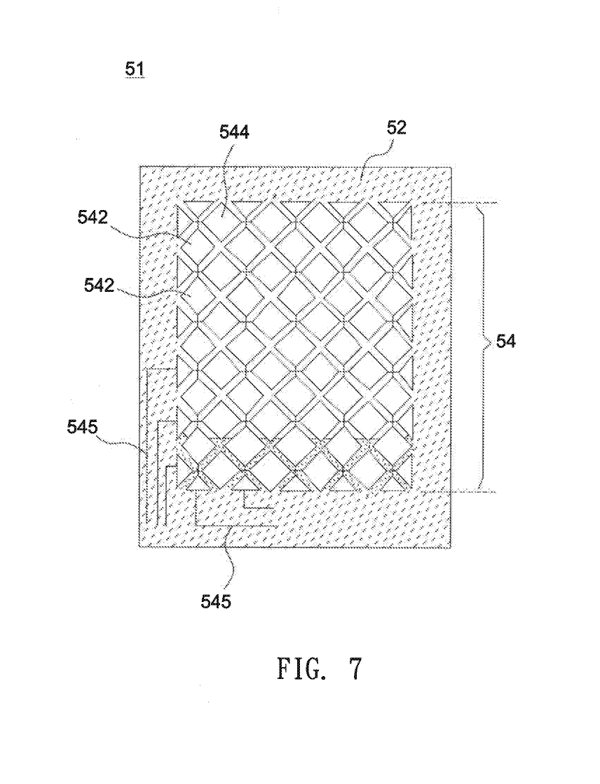

As shown in FIG, 6, a touch-sensitive display device 50 includes a cover lens 51 and a display device 58. Before cutting a mother glass substrate, the mother glass substrate may undergo a mother glass fabrication process, such as film deposition, photolithography, etching, screen printing or ink printing to form a decorative layer 52 and a touch-sensing structure 54. Then, the mother glass substrate is cut to form multiple strengthened glass blocks 20a each serving as a cover lens 51. A side surface 511 of the cover lens 51 is optionally given an etching treatment and a secondary chemically strengthening treatment (such as coating the glass-strengthening coating material 12) to obtain a strengthened cover lens 51. Similarly, display units 55 may be formed on a mother glass substrate by aforementioned mother glass fabrication process, and the mother glass substrate is cut to form multiple strengthened glass blocks 20a each functioning as an array substrate. The array substrate may serve as a bottom substrate 56 of an LCD device or an OLED device, and the array substrate may combine with a color filter substrate or a sealing cap 57 to form a display device 58. Typically, a touch-sensing structure is formed by patterning an electrode layer. For example, as shown in FIG. 7, a touch-sensing structure 54 mainly includes multiple vertically extending first sensing series 542 and horizontally extending second sensing series 544. A dielectric layer is disposed at each intersection of the first sensing series 542 and the second sensing series 544 to insulate the first sensing series 542 from the second sensing series 544. Besides, connection wires of the first sensing series 542 or the second sensing series 544 may be disposed beyond or below the dielectric layer, and the connection wires may be made of a transparent conductive material or metal. Conductive traces 545 are formed on the decorative layer 52 or serve as connection wires inside the sensing series 542 or the sensing series 544. The conductive traces 545 may be metallic or transparent. It should be noted that only a part of the conductive traces 545 is depicted, and other part of the conductive traces 545 is omitted from FIG. 7.

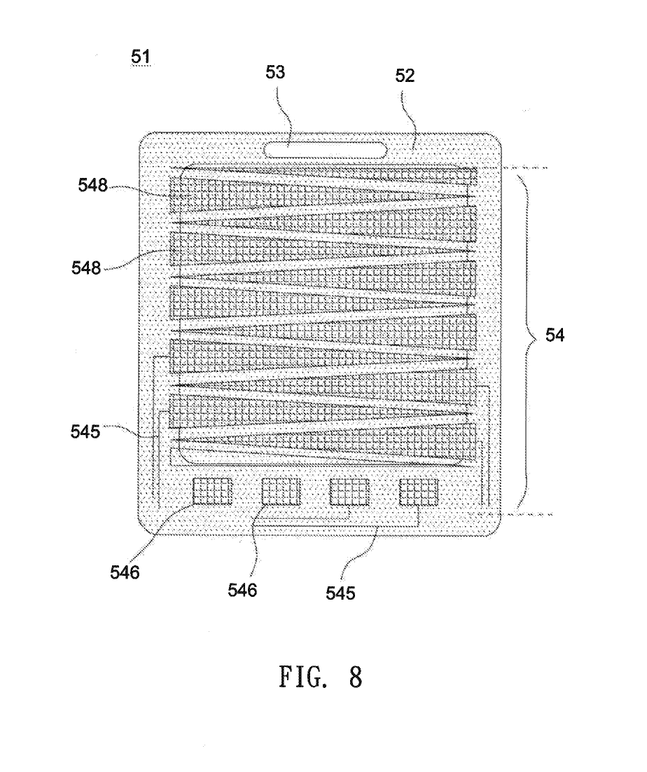

Further, the touch-sensing structure 54 may be formed by patterning a single-layered electrode layer. For example, as shown in FIG. 8, the touch-sensing structure 54 may include button-type single-layered electrodes 546 or triangle-type single-layered electrodes 548. The button-type single-layered electrode 546 or the triangle-type single-layered electrode 548 may be in the form of a transparent electrode pattern or a mesh-wire pattern shown in FIG. 8. The conductive traces 545 are formed on the decorative layer 52, and the conductive traces 545 may be metallic or transparent. Note only a part of the conductive traces 545 is depicted, and other part of the conductive traces 545 is omitted from FIG. 8. At least one hole 53 is formed in the cover lens 51 and overlaps the decorative layer 52. After an etching process and a secondary chemically strengthening treatment (such as coating the glass-strengthening coating material 12) are performed, the strength of a side wall defining the hole 53 is effective increased.

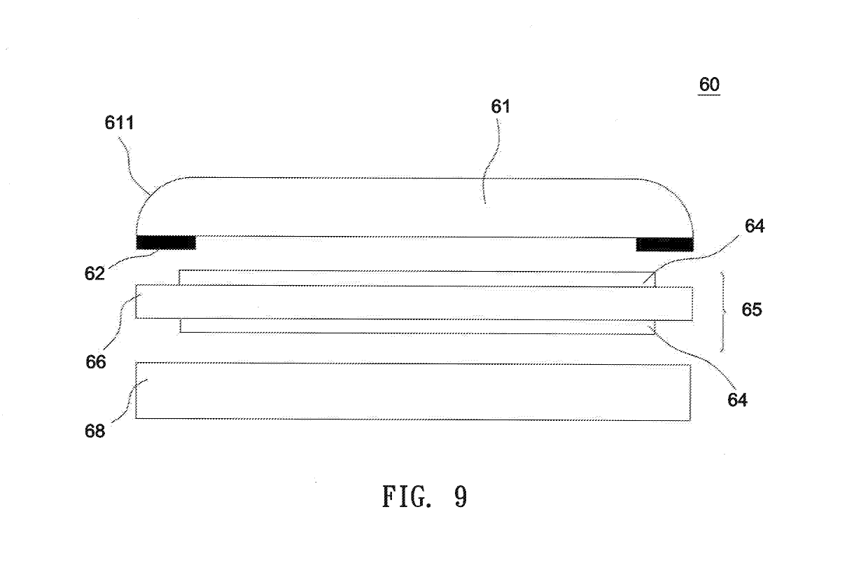

Referring to FIG. 9, in case the strengthened glass block 20a serves as a cover lens, a secondary chemically strengthening treatment may be given to the strengthened glass block 20a having been subject to machining treatments. in this embodiment, at least one side of the cover lens 61 is machined (such as edged and chamfered) to form a curved surface 611, and then the curved surface 611 is given a secondary chemically strengthening treatment (such as coating the glass-strengthening coating material 12). A decorative layer 62 is formed on another surface of the cover lens 61. in this embodiment, a finished cover lens 61, a touch panel 65, and a display device 68 together form a touch-sensitive display device 60, where the touch panel 65 includes a substrate 66 and a touch-sensing structure 64. As shown in FIG. 9, the touch-sensing structure 64 may be, but not limited to, disposed on two sides of the substrate 66. In an alternate embodiment, the touch-sensing structure 64 may be disposed on only one side of the substrate 66.

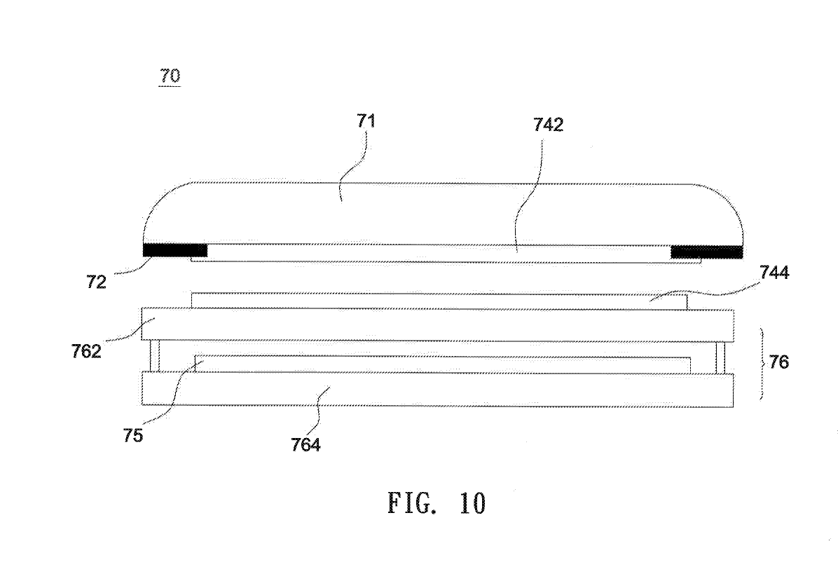

Referring to FIG. 10, in one embodiment, the strengthened glass block 20a of a touch-sensitive display device 70 may undergo a mother glass fabrication process, such as film deposition, photolithography, etching, screen printing or ink printing to form a decorative layer 72 and a touch-sensing structure 742, and then the mother glass substrate is cut to form multiple small pieces each serving as a cover lens 71. In contrast to above embodiments, another touch-sensing structure 744 according to this embodiment is directly disposed on a color filter substrate 762 of a display device 76, and the touch-sensing structures 742 and 744 together form a touch-sensing device. The touch-sensing structures 742 and 744 may be patterned electrode layers. The display device 76 may further include a bottom substrate 764 and a display unit 75 disposed on the bottom substrate 764. The bottom substrate 764, the display unit 75, and the color filter substrate 762 together form the display device 76.

In an alternate embodiment, the touch-sensing structure 744 may be omitted from the display device 76, and touch-sensing operations are performed only by the touch-sensing structure 742 of the display device 76 with touch-sensing functions. The touch-sensing structure 742 may be in the form of single-layer electrodes or multi-layered electrodes. Besides, in this embodiment, the color filter substrate 762 is replaced with a sealing cap of an OLED. The cover lens 71 combines with the display device 76 with touch-sensing functions to form a touch-sensitive display device 70 protected by strengthened glass.

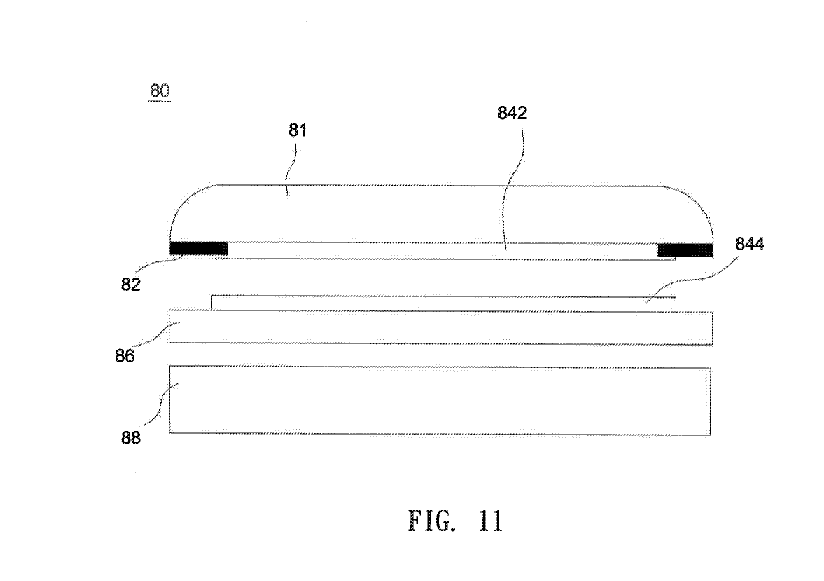

As shown in FIG. 11, contrast to the above embodiment, touch-sensing structures 842 and 844 in this embodiment are respectively disposed on a cover lens 81 of a touch-sensitive display device 80 and a transparent substrate 86. in that case, the cover lens 81 combines with the transparent substrate 86 and a display device 88 to form a touch-sensitive display device 80 protected by strengthened glass.

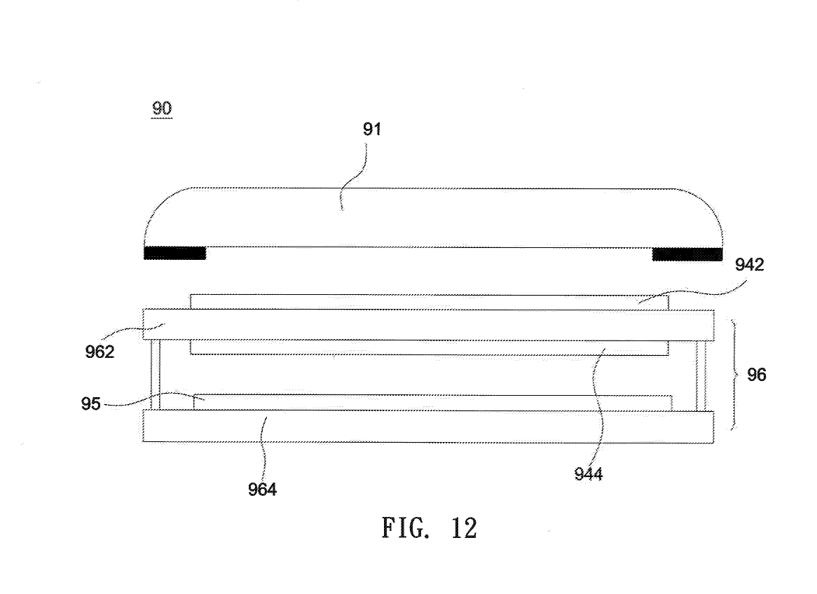

As shown in FIG. 12, in a touch-sensitive display device 90, touch-sensing structures 942 and 944 are respectively formed on two opposite surfaces of a sealing cap 962 of an OLED device 96. A display unit 95 is disposed. on a bottom substrate 964. The sealing cap 962, the bottom substrate 964 or the cover lens 91 may be made of a strengthened glass block and applied with a glass-strengthening coating material 12 exemplified in the above embodiments.

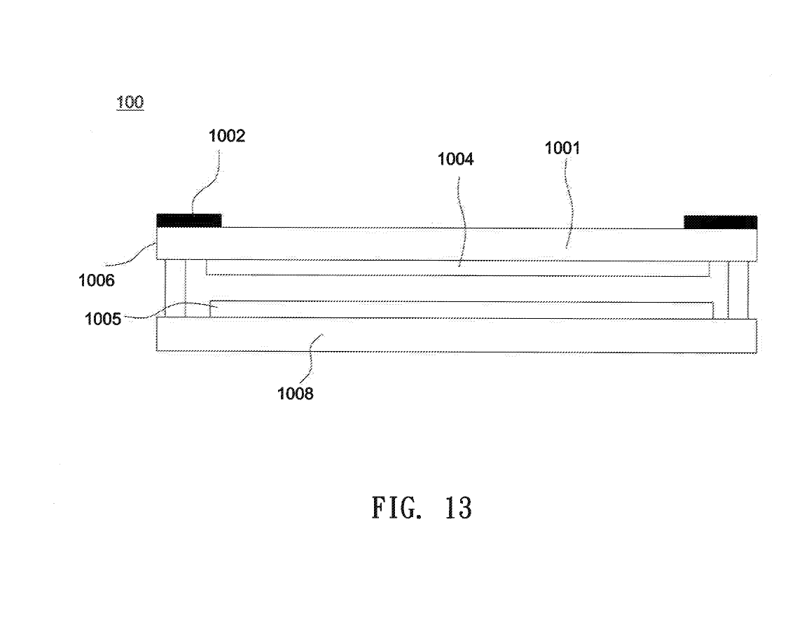

Referring to FIG. 13, in this embodiment, a cover lens 1001 that is strengthened according to the above embodiments serves as a sealing cap of an OLED device 100, and a touch-sensing structure 1004 is formed on the strengthened cover lens 1001. An OLED unit 1005 is disposed on a bottom substrate 1008 and combines with the cover lens 1001 to form a touch-sensitive display device protected by strengthened glass. Though a decorative layer 1002 shown in FIG. 13 is disposed on a top surface of the cover lens 1001, this is not limited. The decorative layer 1002 may be disposed on a bottom surface of the cover lens 1001 instead. Further, a side surface 1006 of the cover lens 1001 may be a planar surface or a curved surface, and the decorative layer 1002 may be disposed on the curved surface.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” is only a nomenclature used to modify its corresponding element. These terms are not used to set up the upper limit or lower limit of the number of elements.

What is claimed is:

1. A glass-strengthening coating material applied to a surface area without a strengthened layer or a newly-born surface area of a strengthened glass block subject to a preliminary chemically strengthened treatment, wherein the newly-born surface area is formed by a machining or material removing treatment, and the glass-strengthening coating material is selected from the group consisting of inorganic polymer, organic polymer, and organic/inorganic hybrid polymer.

2. The glass-strengthening coating material as claimed in claim 1, wherein the inorganic polymer is derived from organic silane.

3. The glass-strengthening coating material as claimed in claim 2, wherein the organic silane is formed by a sol-gel method.

4. The glass-strengthening coating material as claimed in claim 3, wherein the inorganic polymer derived from organic silane is silicon oxide sol-gel, the silicon oxide sol-gel is derived by hydrolysis and polymerization of a silane precursor, and the silane precursor is tetraethoxysilane, tetramethoxysilane, vinyltritnethoxysilane, or methyl trimethoxysilane.

5. The glass-strengthening coating material as claimed in claim 3, wherein the inorganic polymer derived from organic silane is silicon oxide sol-gel, and the glass-strengthening coating material further comprises potassium salt being 1-30 wt % of the glass-strengthening coating material.

6. The glass-strengthening coating material as claimed in claim 5, wherein the potassium salt comprises at least one of potassium dihydrogen phosphate, potassium manganate, potassium ferrate, potassium nitrate, potassium formate, potassium ferric oxalate, and aluminium potassium sulfate.

7. The glass-strengthening coating material as claimed in claim 1, wherein the organic polymer is derived from thermo-polymerizable resin or photo-polymerizable resin.

8. The glass-strengthening coating material as claimed in claim 7, wherein the photo-polymerizable resin is ultraviolet-polymerizable resin.

9. The glass-strengthening coating material as claimed in claim 1, wherein the organic/inorganic hybrid polymer is acrylate/silicon oxide hybrid polymer formed by acrylate and silicon oxide sol-gel.

10. The glass-strengthening coating material as claimed in claim 9, wherein the acrylate is 2-hydroxyethyl methacrylate or dipentaerythritol hexacrylate.

11. A strengthened glass block cut from a mother glass substrate given a preliminary chemically strengthening treatment, the strengthened glass block having a preliminary strengthened surface area and at least one newly-born surface area, wherein the newly-born surface area is formed by a machining or material removing treatment, a glass-strengthening coating material is at least formed on the newly-born surface area, and the glass-strengthening coating material is selected from the group consisting of inorganic polymer, organic polymer, and organic/inorganic hybrid polymer.

12. The strengthened glass block as claimed in claim 11, wherein the inorganic polymer is derived from organic silane.

13. The strengthened glass block as claimed in claim 12, wherein the organic silane is formed by a sol-gel method.

14. The strengthened glass block as claimed in claim 13, wherein the inorganic polymer derived from organic silane is silicon oxide sol-gel, the silicon oxide sol-gel is derived by hydrolysis and polymerization of a silane precursor, and the silane precursor is tetraethoxysilane, tetramethoxysilane, vinyltrimethoxysilane, or methyltrimethoxysilane.

15. The strengthened glass block as claimed in claim 13, wherein the inorganic polymer derived from organic silane is silicon oxide sol-gel, and the glass-strengthening coating material further comprises potassium salt being 1-30 wt % of the glass-strengthening coating material.

16. The strengthened glass block as claimed in claim 11, wherein the organic polymer is derived from thermo-polymerizable resin or photo-polymerizable resin.

17. The strengthened glass block as claimed in claim 16, wherein the photo-polymerizable resin is ultraviolet-polymerizable resin.

18. The strengthened glass block as claimed in claim 11, wherein the organic/inorganic hybrid polymer is acrylate/silicon oxide hybrid polymer formed by acrylate and silicon oxide sol-gel.

19. The strengthened glass block as claimed in claim 11, wherein the glass-strengthening coating material is further formed on at least a part of the preliminary strengthened surface area.

20. The strengthened glass block as claimed in claim 11, further comprising:
a touch-sensing structure formed on a surface of the strengthened glass block.

21. The strengthened glass block as claimed in claim 20, further comprising:
a decorative layer formed on a surface of the strengthened glass block, wherein the decorative layer comprises at least one of ceramic, diamond-like carbon, colored ink, photo resist and resin.

22. The strengthened glass block as claimed in claim 11, wherein the strengthened glass block is a transparent substrate of a display panel, a substrate of a touch panel, or a cover lens of a touch panel.

23. The strengthened glass block as claimed in claim 11, wherein the strengthened glass block has a plurality of cut facets, and at least one of the cut facets is in the form of a curved surface.

24. The strengthened glass block as claimed in claim 11, further comprising:
a display unit formed on a surface of the strengthened glass block.

25. A touch-sensitive display device protected by strengthened glass, comprising:
a cover lens;
a glass-strengthening coating material formed on at least a part of the cover lens, wherein the glass-strengthening coating material is selected from the group consisting of inorganic polymer, organic polymer, and organic/inorganic hybrid polymer; and
a touch-sensitive display panel disposed on the cover lens.

26. The touch-sensitive display device as claimed in claim 25, wherein the inorganic polymer is derived from organic silane.

27. The touch-sensitive display device as claimed in claim 26, wherein the organic silane is formed by a sol-gel method.

28. The touch-sensitive display device as claimed in claim 27, wherein the inorganic polymer derived from organic silane is silicon oxide sol-gel, and the glass-strengthening coating material further comprises potassium salt being 1-30 wt % of the glass-strengthening coating material.

29. The touch-sensitive display device as claimed in claim 25, wherein the organic polymer is derived from thermo-polymerizable resin or photo-polymerizable resin.

30. The touch-sensitive display device as claimed in claim 25, wherein the organic/inorganic hybrid polymer is acrylate/silicon oxide hybrid polymer formed by acrylate and silicon oxide sol-gel.
